(19) United States
(12) Patent Application Publication
(10) Pub. No.: US 2018/0133913 A1
(43) Pub. Date: May 17, 2018

(54) ROTATING BLADE SCORING TOOL

(71) Applicant: AccuTec Blades, Inc., Verona, VA (US)

(72) Inventor: Frank Henry PROCHASKA, Waynesboro, VA (US)

(21) Appl. No.: 15/349,726

(22) Filed: Nov. 11, 2016

(51) Int. Cl. B26D 1/18; B26D 7/26; B26B 29/06; B26D 1/00

(52) U.S. Cl. CPC B26D 1/18; B26D 7/2621; B26D 7/22; B26D 1/0006; B26B 29/06

(57) ABSTRACT

A scoring tool includes a handle and a frame coupled to the handle. The scoring tool also includes a plate coupled to the frame. Further, the scoring tool includes a rotating blade rotatably coupled to the frame. The rotating blade extends through an opening of the plate to a scoring depth.

### BACKGROUND

The present disclosure relates generally to systems and methods to produce a score line in a variety of building materials.

Construction, remodeling, and structure finishing services often include cutting various building materials to unique sizes. Many of these materials may be cut to size using sharpened steel blades positioned in handles, such as utility blades. When using a utility blade or other blade in producing a score line, a blade tip is driven into the building material. The blade must then overcome a force provided by the building material against the blade to draw the blade in a direction parallel to the surface of the building material in addition to overcoming the force required to maintain the blade at a desired depth within the building material. Additionally, as the score is made, a flow of the building material past the blade abrades an edge and tip of the blade. As the edge and tip become dull, additional user effort is required and eventually a load on the blade edge results in breakage.

The composition of certain building materials may be such that extreme forces are required to accomplish a full depth cut, which may lead to breakage of the steel blades. Further, in using the utility blades for full depth cuts or scoring cuts, effort is great, control is limited, and lower arm fatigue is likely to occur during the cutting process. The various materials on which the blade is used may be made from abrasive components that quickly dull cutting edges of the steel blades. Accordingly, frequent blade changes may slow work progress. Further, other cutting methods, such as sawing or shearing, may produce the desired size or shape of the various materials, but the methods may generate excess debris or use excessively bulky equipment.

### SUMMARY

The disclosed embodiments provide systems to score building materials. In accordance with an embodiment, a scoring tool includes a handle and a frame coupled to the handle. The scoring tool also includes a plate coupled to the frame. Further, the scoring tool includes a rotating blade rotatably coupled to the frame. The rotating blade extends through an opening of the plate to a scoring depth.

In accordance with another illustrative embodiment, a scoring tool includes a handle and a rotating blade that is disposed around a bearing. Additionally, the scoring tool includes a frame coupled to the handle. The frame includes multiple passages, and each passage is capable of receiving the fastening element to removably couple the rotating blade to the frame. The scoring tool also includes a plate coupled to the frame, and the plate includes an opening that allows the rotating blade to extend through the plate to a scoring depth. When the fastening element is secured to a first passage of the multiple passages, the rotating blade extends beneath the plate at a first depth. Additionally, when the fastening element is secured to a second passage of the multiple passages, the rotating blade extends beneath the plate at a second depth.

In accordance with another illustrative embodiment, a rotating blade includes an edge base. The edge base includes a through port in a central portion of the edge base. Additionally, the rotating blade includes a bearing disposed within the through port of the edge base. The bearing, in operation, is carried by an axle of a fastening element that couples the rotating blade to a frame of a scoring tool. Further, the rotating blade includes a radiused edge. In an embodiment, the radiused edge has two facets, and the two facets converge at an angle less than 45 degrees.

Additional details of the disclosed embodiments are provided below in the detailed description and corresponding drawings.

### BRIEF DESCRIPTION OF THE DRAWINGS

Illustrative embodiments of the present invention are described in detail below with reference to the attached figures, which are incorporated by reference herein, and wherein:

FIG. 1 is a perspective view of a scoring tool, in accordance with an embodiment.

FIG. 2 is a side view of a fastening element and a cutaway of the rotating blade of the scoring tool, in accordance with an embodiment.

FIG. 3 is a side view of the scoring tool and a top view of an edge guide, in accordance with an embodiment.

FIG. 4 is a section view of an embodiment of the scoring tool, in accordance with an embodiment.

FIG. 5 is a flowchart of a method for scoring and shaping selected materials using the scoring tool, in accordance with an embodiment.

The illustrated figures are only exemplary and are not intended to assert or imply any limitation with regard to the environment, architecture, design, or process in which different embodiments may be implemented.

### DETAILED DESCRITPION

In the following detailed description of several illustrative embodiments, reference is made to the accompanying drawings that form a part hereof, and in which is shown by way of illustration specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. Further, any use of any form of the terms “connect,” “engage,” “couple,” “attach,” or any other term describing an interaction between elements includes items integrally formed together without the aid of extraneous fasteners or joining devices. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

The subject matter disclosed in the present application provides systems and methods for safely and efficiently producing a score line in various building materials. The score line in the various building materials may enable an operator to flex and cleanly break the building materials along the score line to safely produce uniquely sized pieces of the building materials. Further, the subject matter relates to a rotating blade that produces the score line. Generally, rolling an item (e.g., the rotating blade) provides greater efficiency than sliding an item.

As used herein, the term “building materials” may refer to luxury vinyl tile (LVT) flooring, drywall (i.e., gypsum wallboard), or any other materials that may benefit from the addition of score lines. A steel blade may generally not be capable of cutting through such building materials. However, if a score line is produced in the building material that is approximately 10 to 20 percent of a thickness of the building material, the building material may be flexed along the score line to neatly break the building material at the score line.

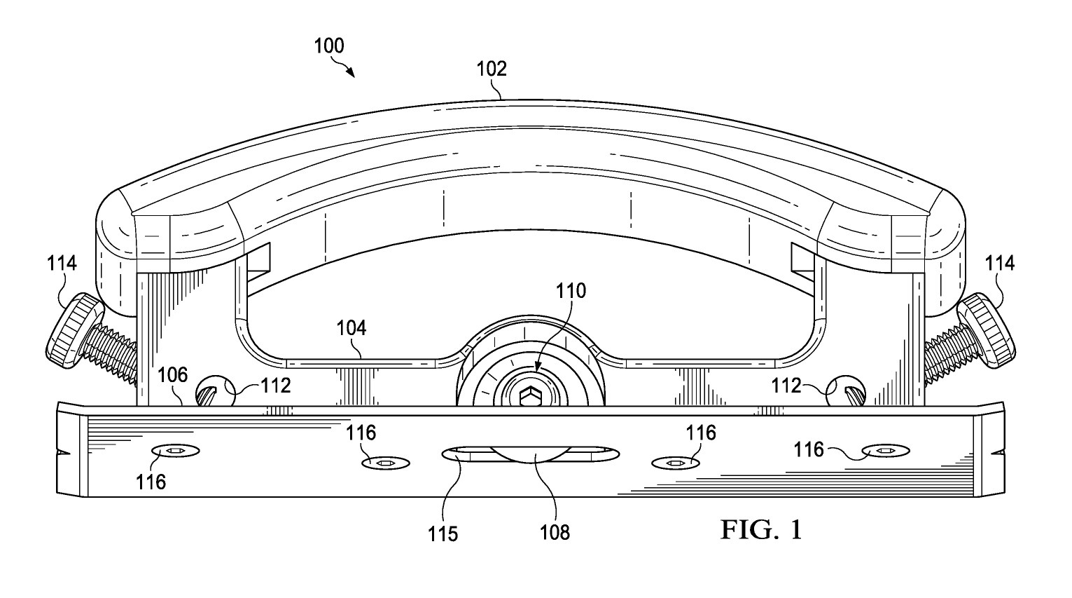

FIG. 1 is a perspective view of a scoring tool 100, in accordance with an embodiment. The scoring tool 100 may include a handle 102, a frame 104, a plate 106, and a rotating blade 108. The handle 102 may be ergonomically shaped to fit a hand of a user of the scoring tool 100 while producing a score line in a building material. Additionally, the handle 102 may enable transmission of force from the user to the scoring tool 100, and the handle 102 may also provide user control of the scoring tool 100 during a scoring process. The handle 102 may be made from a polymer, a composite, wood, or any other material to provide sufficient rigidity to provide user control of the scoring tool 100 and comfort to reduce hand fatigue of the user. In some embodiments, the scoring tool 100 may include a body having a substantially planar surface adapted to engage a surface of a material to be scored. In such an embodiment, the body has an opening in the substantially planar surface through which the rotating blade 108 extends. Further, the body, in some embodiments, includes the handle 102, the frame 104, and the plate 106, as illustrated in FIG. 1.

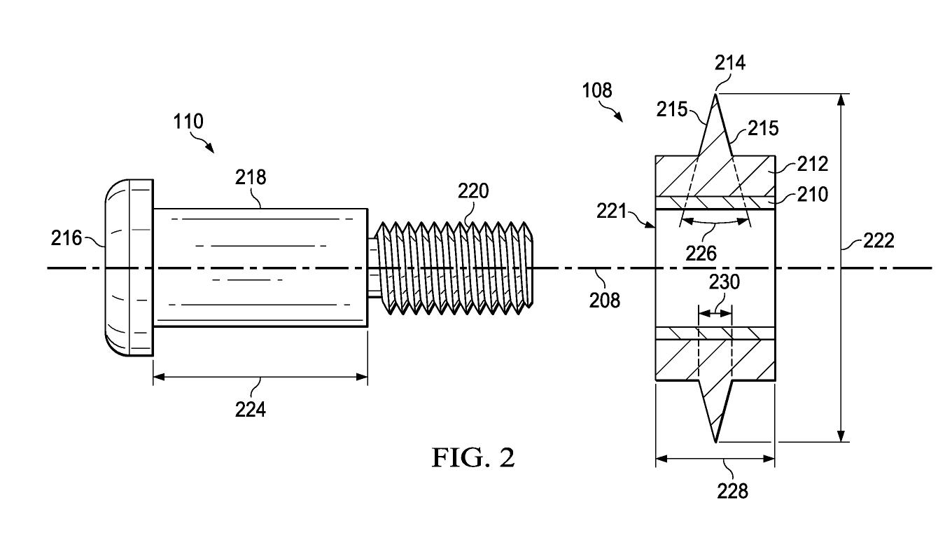

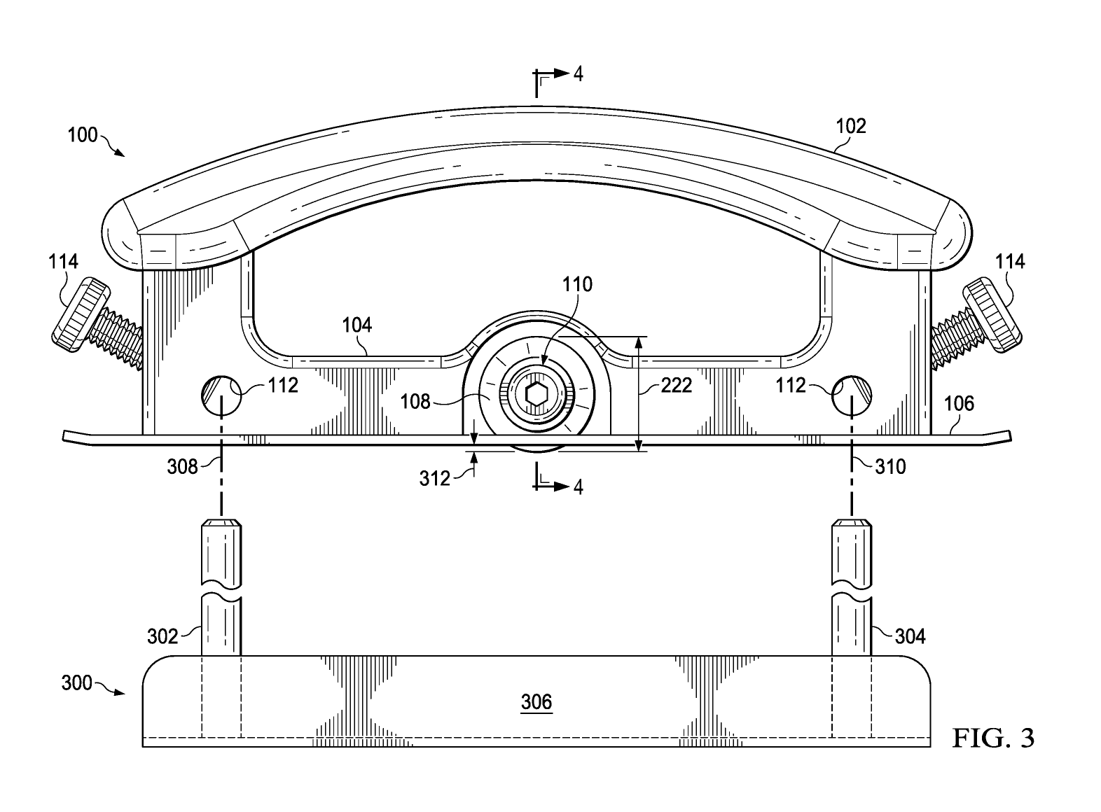

The rotating blade 108 may be rotatably coupled to the frame 104 by a fastening element 110. As depicted, the fastening element 110 is a threaded bolt with a smooth surface, and the fastening element 110 acts as an axle about which the rotating blade 108 is capable of rotating. A bearing assembly, as described in FIG. 2, may be provided between the fastening element 110 and the rotating blade 108 to improve rotational efficiency. The fastening element 110 may also be a more permanent fixture, such as a rivet, that extends through a middle portion of the rotating blade 108, provides a smooth surface (i.e., an axle) for interaction with the bearing of the rotating blade 108, and secures the rotating blade 108 to the frame 104. The frame 104 may also include through holes 112 and thumb screws 114 that are capable of receiving and securing an edge guide, as depicted in FIG. 3, respectively. Additionally, the frame 104 may generally be made from light weight die cast aluminum or magnesium.

In some embodiments, the plate 106 provides a smooth surface that enables the scoring tool 100 to slide along the building material during a scoring process without blemishing the building material. The plate 106 may be made from stamped steel with hard nickel or chrome plating. The rotating blade 108 may extend through an opening 115 of the plate 106 to a scoring depth that the scoring tool 100 achieves in a building material. As discussed in detail below, the scoring depth may vary based on a diameter of the rotating blade 108, a location of the fastening element 110 in relation to the frame 104 and the plate 106, or any combination thereof. Further, while the scoring depth is described herein as a depth at which the scoring tool 100 produces a score line in the building material, it may be appreciated that, for thin building materials, the scoring tool 100 may provide a complete cut through the building materials.

The frame 104 may be coupled to the handle 102 by a coupling device (not shown). The coupling device may be a screw that is seated in the frame 104 and extends into or through the handle 102. Alternatively, the coupling device may include components that provide a snap-fit connection, an industrial adhesive, or any other suitable coupling device that permanently or removably couples the handle 102 to the frame 104. Similarly, the frame 104 may be coupled to the plate 106 using coupling devices 116. The coupling devices 116 may be screws, rivets, or any other types of fastening components, to couple the frame 104 to the plate 106.

FIG. 2 illustrates a side view of the fastening element 110 and a cutaway of the rotating blade 108 of the scoring tool 100, in accordance with an embodiment. In operation, the fastening element 110 may fit within the rotating blade 108 along an axis 208. The rotating blade 108 may include a bearing 210, an edge base 212, and an edge 214. Two facets 215 may come together to produce the edge 214. The fastening element 110 may include a head 216, which interacts with a tightening tool such as a screwdriver or a hex key. The fastening element 110 may also include an axle 218 and a fastening component 220. By way of example, the fastening component 220 may include threads that interact with corresponding threads within the frame 104 of the scoring tool 100 to maintain the fastening element 110 in place within the frame 104. Alternatively, the fastening component 220 may include a retaining clip, a cotter key, a set screw, or any other fastening device capable of maintaining the fastening element 110 in place within the frame 104. The axle 218 of the fastening element 110 passes through a passage 221 of the bearing 210 of the rotating blade 108. In this manner, the axle 218 allows rotation and transfers force from a user to the rotating blade 108.

The rotating blade 108 has a diameter 222. In some embodiments, the diameter 222 is approximately 19 millimeters. In other embodiments, the diameter 222 may be within a range of approximately 11 millimeters to 26 millimeters. Further, it may be appreciated that the diameter 222 may be as large as 75 millimeters or as small as 5 millimeters in some embodiments. As the diameter 222 increases, force applied in a direction of a score line (e.g., forward or rearward) on the rotating blade 108 to produce an adequate score line decreases. However, as the diameter 222 increases, normal force applied on the rotating blade 108 to achieve depth of the score line increases. Additionally, a smaller diameter 222 may cause failure of the bearing 210 and the axle 218 due to a lack of robustness. Moreover, the edge base 212 may have a width 228 of approximately 6.35 millimeters, and a portion of the edge 214 that couples to the edge base 212 may have a width 230 of approximately 1 millimeter.

The rotating blade 108 operates with less force overall than a blade that does not rotate, such as in a utility knife, and a user focuses effort directly to the rotating blade 108 through the handle 102. Accordingly, the rotating blade 108 may limit lower arm fatigue experienced by the user during a scoring process. Furthermore, a rolling nature of the rotating blade 108 reduces a sliding and wearing force component from a total force requirement for generating the score line that a utility blade may experience. Moreover, scoring may be accomplished at a high rate using the rotating blade 108. For example, the rotating blade 108 may have an increased longevity over a blade that does not rotate. Therefore, more time is spent performing the actual task (e.g., laying LVT flooring) and not servicing a cutting tool (e.g., by replacing a broken or worn out blade). Score lines in the building material are generated by the rotating blade 108 by moving the scoring tool 100 in either a forward direction or a rearward direction. That is, the rotating blade 108 generates score lines by moving to the right or the left, respectively, in relation to an orientation of the scoring tool 100 illustrated in FIG. 1.

In an embodiment, the width 228 of the edge base 212 is approximately 6.35 millimeters thick to provide support for the bearing 210, and the bearing 210 may be unlubricated. For example, in some embodiments, the bearing 210 is a thin shell polymer sleeve bearing. Additionally, a journal length 224 of the axle 218 may be slightly larger than the width 228 of the bearing 210. For example, when the bearing 210 has the width 228 of 6.35 millimeters, the journal length 224 may be approximately 6.5 millimeters.

The edge 214 is generated by the convergence of the two facets 215. The two facets 215 are symmetrical with an angle 226 of approximately 28 degrees. In other embodiments, the angle 226 may be in the range of approximately 15 degrees to 40 degrees. Further, in an embodiment, the edge 214 is made from an air hardening tool steel. In other embodiments, the edge 214 may be made from other grades of air or oil hardening steels in addition to lower carbon alloy steels intended for carburizing after machining to a net shape. Moreover, the edge 214 may be intentionally radiused, as opposed to a finely honed edge of a utility blade. Efficiency of a rolling scoring method provided by the rotating blade 108 enables a radiused edge 214 to score building material effectively while providing extended life of the rotating blade 108 and enhanced safety features. The range of the scoring edge radius may be from approximately 0.025 millimeters to approximately 0.10 millimeters.

FIG. 3 is a side view of the scoring tool 100 and a top view of an edge guide 300, in accordance with an embodiment. The edge guide 300 includes arms 302 and 304 and a guide portion 306. The guide portion 306, in operation, runs along an edge of a piece of building material in such a manner that the scoring tool 100 generates a straight score line at a desired distance from an edge of the building material during operation of the scoring tool 100 and the edge guide 300. In an embodiment, the arms 302 and 304 are installed along axes 308 and 310, respectively, into the through holes 112 of the scoring tool 100. Once the arms 302 and 304 have been installed to generate a desired separation between the rotating blade 108 and the guide portion 306, the thumb screws 114 are tightened to lock the edge guide 300 in position. While the edge guide 300 may be beneficial for maintaining a constant distance from an edge of a piece of building material, in some instances, the use of the edge guide 300 may not be beneficial or desirable. For example, in an embodiment, a user may follow a chalk line already marked where the score line is desired, or the scoring tool 100 may be used to cut a score line at an angle to an edge of the building material.

Also illustrated is a depth 312 that the rotating blade 108 extends beneath the plate 106. The depth 312 indicates a depth of a score line produced on the building material. In some embodiments, the depth 312 may be approximately 10 to 20 percent of a thickness of the building material in which the score line is produced. Additionally, in some embodiments, the depth 312 may be adjusted by changing the diameter 222 of the rotating blade 108, and/or the depth 312 may be adjusted by changing a location of the fastening element 110 within the frame 104. For example, for an increase in the depth 312, the diameter 222 may be increased and/or the location of the fastening element 110 may be moved toward the plate 106. Further, for a decrease in the depth 312, the diameter 222 may be decreased and/or the location of the fastening element 110 may be moved toward the handle 102.

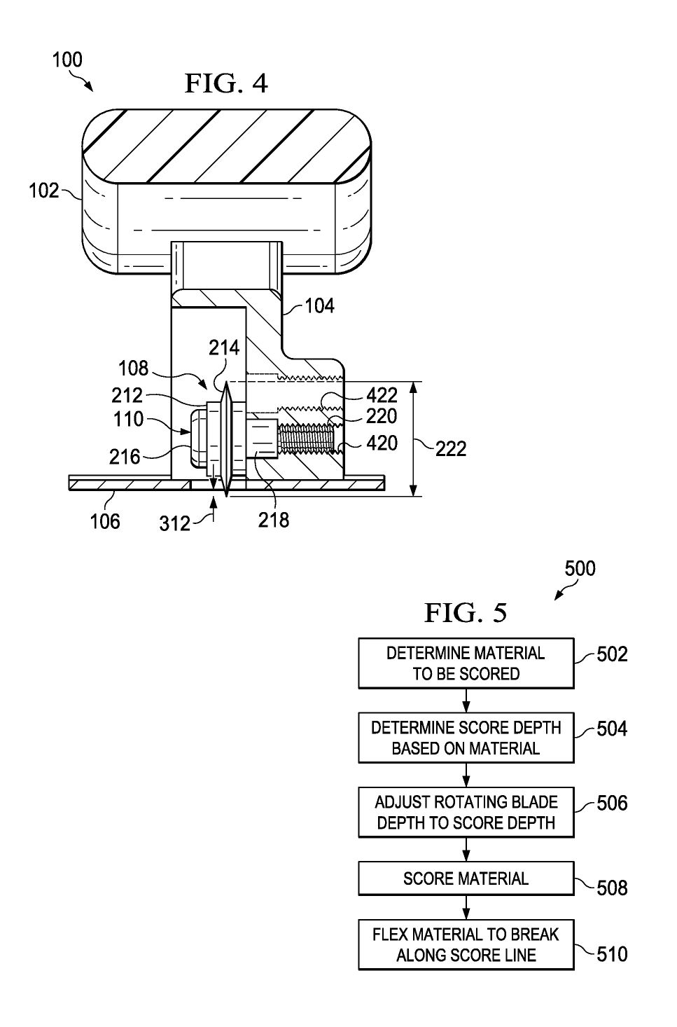

FIG. 4 is a section view of an embodiment of the scoring tool 100 taken from lines 4-4 of FIG. 3, in accordance with an embodiment. As depicted, the fastening element 110 is seated through the rotating blade 108 and into a fastening element seat 420. The fastening element seat 420 includes a portion that receives part of the axle 218 to provide increased stability of the fastening element 110 during operation. Further, in an embodiment, the fastening element seat 420 includes a threaded portion that receives threads of the fastening component 220. By threading the fastening element 110 into the fastening element seat 420, the fastening element 110 secures the rotating blade 108 to the scoring tool 100.

Also depicted is an optional fastening element seat 422 represented by dashed lines. The optional fastening element seat 422 provides an alternative arrangement for the rotating blade 108 within the scoring tool 100. For example, as discussed above, to generate a shallower score line in the building material, the fastening element 110 may be move toward the handle 102. Accordingly, the optional fastening element seat 422 provides a position for installation of the fastening element 110 that enables a shallower score line in the building material without changing the diameter 222 of the rotating blade 108. Further, should a larger diameter 222 of the rotating blade 108 be desired while maintaining the same depth 312, the optional fastening element seat 422 may accomplish such a configuration. It may be appreciated that while only two fastening element seats 420 and 422 are depicted, several additional fastening element seats are contemplated to provide several different positions of the rotating blade 108 within the scoring tool 100.

By changing the fastening element seat 420 or 422 in which the fastening element 110 is positioned, and/or changing the diameter 222 of the rotating blade 108, a user is able to adjust the depth 312 of the rotating blade 108. Adjusting the depth 312 of the rotating blade 108 will also adjust a depth of a score line generated by the scoring tool 100. For example, if the fastening element 110 is positioned within the fastening element seat 422, a score line generated by the scoring tool 100 will be shallower than a score line generated by the scoring tool 100 with the fastening element 110 positioned within the fastening element seat 420, assuming the diameter 222 of the rotating blade 108 is the same. In another embodiment, a larger diameter 222 of the rotating blade 108 may produce a deeper score line than a smaller diameter 222 of the rotating blade 108 when the fastening element 110 is positioned within the same fastening element seat 420 or 422. Therefore, the depth of the score line may vary based on which of the fastening element seats 420 or 422 is used and what diameter 222 of the rotating blade 108 is used.

FIG. 5 is a flowchart 500 of a method for scoring selected and shaping materials using the scoring tool 100, in accordance with an embodiment. Initially, at block 502, a material to be scored is determined by a user of the scoring tool 100. The material may include luxury vinyl tile (LVT) planks, drywall (e.g., gypsum wallboard), or any other building material that provides a clean break along a score line upon flexing the building material along the score line.

As mentioned above, a desired score depth may vary based on the type of material being shaped and a thickness of the type of material being shaped. Accordingly, at block 504, the score depth is determined based on the type of building material. Generally, the desired score depth is between 10 and 20 percent of the thickness of the building material. A score depth greater than 20 percent may prematurely wear down the rotating blade 108 and unnecessarily increase effort exerted by a user to achieve the score depth. Alternatively, a score depth less than 10 percent may not produce a clean break of the building material along the score line. It may be appreciated, however, that for some building materials, a score depth of less than 10 percent may still provide a clean break. Additionally, for some building materials, a score depth of greater than 20 percent may be desired to ensure a clean break of the building materials.

With this in mind, a user adjusts the depth 312 of the rotating blade 108, at block 506, based on the desired depth of the score line. As discussed above, the depth 312 of the rotating blade 108 is adjusted by changing the rotating blade 108 to a rotating blade 108 with a larger or smaller diameter 222. Additionally or alternatively, the depth 312 of the rotating blade 108 is adjusted by changing the position of the fastening element 110 within the frame 104. For example, the fastening element 110 may be moved toward the handle 102 (e.g., positioned within the fastening element seat 422) to decrease the depth 312, or the fastening element 110 may be moved toward the plate 106 (e.g., positioned within the fastening element seat 420) to increase the depth 312.

At block 508, the building material is scored using the adjusted scoring tool 100. While scoring the building material, the scoring tool 100 may use the edge guide 300 to maintain a straight score line across the building material. In some embodiments, several passes of the scoring tool 100 across the building material are performed to achieve the desired depth 312.

After generating the score line on the building material, the building material is flexed, at block 510, to break the building material along the score line. Flexing the building material may be performed by hand to produce a clean break of the building material along the score line. By breaking the material along the score line, excess debris is avoided from the use of tools such as tools that saw or shear. Additionally, excess tools are also avoided that are generally bulky and may involve constant repositioning to follow the work flow.

While this specification provides specific details related to certain components of the scoring tools, it may be appreciated that the list of components is illustrative only and is not intended to be exhaustive or limited to the forms disclosed. Other components of the scoring tools will be apparent to those of ordinary skill in the art without departing from the scope and spirit of the disclosure. Further, the scope of the claims is intended to broadly cover the disclosed components and any such components that are apparent to those of ordinary skill in the art.

The above disclosed embodiments have been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flow diagram depicts serial processes, some of the steps/blocks may be performed in parallel or out of sequence, or combined into a single step/block. The scope of the claims is intended to broadly cover the disclosed embodiments and any such modification.

It should be apparent from the foregoing disclosure of illustrative embodiments that significant advantages have been provided. The illustrative embodiments are not limited solely to the descriptions and illustrations included herein and are instead capable of various changes and modifications without departing from the spirit of the disclosure.

What is claimed is:

1. A scoring tool, comprising:
a body having a substantially planar surface adapted to engage a surface of a material to be scored, the body having an opening in the substantially planar surface; and
a rotating blade rotatably coupled to the body, wherein the rotating blade extends through the opening of the body to a scoring depth.

2. The scoring tool of claim 1, wherein the body comprises a handle, a frame coupled to the handle, and a plate coupled to the frame.

3. The scoring tool of claim 1, wherein the body is configured to slide across a surface of building material in which a score line is produced by the scoring tool.

4. The scoring tool of claim 1, wherein rotating blade comprises a radiused edge.

5. The scoring tool of claim 4, wherein the radiused edge comprises a radius of between 0.025 millimeters and 0.10 millimeters

6. The scoring tool of claim 1, wherein the rotating blade is configured to produce a score line in a building material while the scoring tool moves in either a forward direction or a rearward direction.

7. The scoring tool of claim 1, wherein the body comprises at least one through hole, and the at least one through hole is configured to receive an arm of an edge guide.

8. The scoring tool of claim 1, wherein the rotating blade is removably coupled to the body.

9. The scoring tool of claim 1, wherein the rotating blade comprises two facets, and the two facets converge at an edge of the rotating blade at an angle between 15 degrees and 40 degrees.

10. The scoring tool of claim 1, wherein the scoring depth comprises a depth that is between 10 percent and 20 percent of a thickness of building material in which a score line is produced by the scoring tool.

11. The scoring tool of claim 1, wherein the body comprises multiple passages that are each configured to receive a fastening element that rotatably couples the rotating blade to the body.

12. A scoring tool, comprising:
a handle;
a rotating blade disposed around a bearing;
a fastening element configured to interact with the bearing disposed within the rotating blade;
a frame coupled to the handle, the frame comprising multiple passages, each passage configured to receive the fastening element to removably couple the rotating blade to the frame; and
a plate coupled to the frame, the plate comprising an opening that enables the rotating blade to extend through the plate to a scoring depth;
wherein when the fastening element is secured to a first passage of the multiple passages, the rotating blade extends beneath the plate at a first depth, and when the fastening element is secured to a second passage of the multiple passages, the rotating blade extends beneath the plate at a second depth.

13. The scoring tool of claim 12, wherein the rotating blade comprises an edge base, the edge base comprising a through port in a central portion of the edge base that interacts with the bearing.

14. The scoring tool of claim 12, wherein the fastening element comprises an axle configured to interact with the bearing disposed within the rotating blade to produce rotation of the rotating blade.

15. The scoring tool of claim 12, wherein the rotating blade comprises two facets, and the two facets converge at a radiused edge of the rotating blade at an angle between 15 degrees and 40 degrees.

16. A rotating blade, comprising:
an edge base, the edge base comprising a through port in a central portion of the edge base;
a bearing disposed within the through port of the edge base, the bearing configured to interact with an axle of a fastening element that couples the rotating blade to a frame of a scoring tool; and
a radiused edge comprising two facets, wherein the two facets converge at an angle less than 45 degrees.

17. The rotating blade of claim 16, wherein the radiused edge comprises a radius of between 0.025 millimeters and 0.10 millimeters

18. The rotating blade of claim 16, wherein the bearing comprises a thin shell polymer bearing.

19. The rotating blade of claim 16, wherein the two facets converge at the radiused edge of the rotating blade at the angle between 15 degrees and 40 degrees.

20. The rotating blade of claim 16, wherein the two facets couple to the edge base at a point where the two facets are 1 millimeter apart.

21. A scoring tool, comprising:
a handle;
a frame coupled to the handle;
a plate coupled to the frame; and
a rotating blade rotatably coupled to the frame, wherein the rotating blade extends through an opening of the plate to a scoring depth, and the rotating blade comprises:
an edge base, the edge base comprising a through port in a central portion of the edge base;
a bearing disposed within the through port of the edge base, the bearing configured to interact with an axle of a fastening element that couples the rotating blade to a frame of a scoring tool; and
a radiused edge comprising two facets, wherein the two facets converge at an angle less than 45 degrees.
